(19) United States
(12) Patent Application Publication
(10) Pub. No.: US 2019/0057427 A1
(43) Pub. Date: Feb. 21, 2019

(54) Anonymous Match Engine and Trimodal Negotiation System

(71) Applicant: Mosami Dhaval Shah, Thousand Oaks, CA (US)

(72) Inventor: Mosami Dhaval Shah, Thousand Oaks, CA (US)

(21) Appl. No.: 16/105,921

(22) Filed: Aug. 20, 2018

Related U.S. Application Data
(60) Provisional application No. 62/547,873, filed on Aug. 20, 2017.

(51) Int. Cl. G06Q 30/06; G06F 17/30

(52) U.S. Cl. CPC G06Q 30/0615; G06Q 30/0619; G06Q 30/0625; G06F 17/30595; G06Q 30/0641; G06Q 30/0617

(57) ABSTRACT

Blackbox describes an unbiased match engine which preserves the identity of all the parties involved until an anonymity match and mutual interests or deal terms match their individual needs. One match engine system embodiment is known as RoboNegotiator™ which acts as a third-party negotiator, mediator, broker, introducer and anonymous facilitator operating independently without having business interest with either party and without letting involved parties game the system. A partial compare enables a negotiation for a remaining unmatched data concurrently, in one of an unbiased automated, semi-automated and non-automated modes. The entity requesting matching services will never be sure if there is any matching interest or if all terms and conditions are really met or not. There is no risk of identity exposure if there is no mutual interest or deal and hence the disclosed match engine will also preserve “confidentiality” of interest, deal terms and dreams.

### CROSS-REFERENCE TO RELATED APPLICATION

This application claims priority to earlier filed U.S. Patent Application 62/547,873 titled ‘An Unbiased, Generic and Anonymous Match engine,’ filed Aug. 20, 2017 by Mosami Dhaval Shah and claims the benefit of the earlier filing date and is incorporated herein by reference in its entirety.

### BACKGROUND

Most Internet companies in contemporary business have used the capabilities of a specific purpose driven match engine as part of their solution to offer their products or services through matching the attributes/qualities of their products/services to that of requests from their clients/customers. Their match algorithm is based on specific needs and caters to only their products/services. Their match engine includes no other dimension offered to consumers. For example: Zillow.com provides a match engine for the housing market (sell and purchase of homes) whereas expedia.com or hotwire.com provides matching services for the travel market as is commonly known. These companies are acting as middlemen (or platform providers) where sellers and buyers come to gather and some consideration or commission is charged for providing matching services. These are specific purpose driven match engine products which are widely used at present.

However, all of these conventional match engines and systems surrounding respective match engines fall short as an unbiased, generic and anonymous match engine for facilitating business deals between users.

### SUMMARY OF THE INVENTION

A disclosed match engine and trimodal negotiation system utilizing the match engine matches a user's identity and anonymity attributes and based thereon also matches a relational data of the user with other users via circuits, modules, systems and non-transitory processor-readable storage media instructions. The disclosure also includes a partial compare module configured to match on a partial relational data and enable a negotiation for a remaining unmatched data concurrently, in one of an unbiased automated, semi-automated and non-automated mode. The fully relational database saves an anonymity preference order for a plurality of existing user's with respective relational data including items or services advertised and traded in commerce for consideration. The match engine also includes a matching engine configured to compare a new user's anonymity preference order for an anonymity match in the fully relational database against an anonymity preference order for all existing users. Additionally, a match engine logic is configured to compare the new user's relational data for a relational match in the fully relational database against a respective relational data for all existing users.

A request watcher module continuously watches for any new match requests at a request dump folder and notify the matching engine thereof for processing. A request receiver takes match requests from a web service application programming interface and passes them to a request dump folder or database. The request dump folder stores match requests and passes respective data associated with the match requests to the match engine for comparing and processing. A responder module passes anonymity and relational information regarding clients of a match event from the match database to a notification module. Multiple match requests are processed simultaneously in different threads starting at a request dump and continuing through a request watcher, the match engine and logic to a responder module.

### BRIEF DESCRIPTION OF THE DRAWINGS

FIG. 1 is a block diagram of system components for an unbiased, generic and anonymous match engine in accordance with an embodiment of the present disclosure.

FIG. 2 is a detail diagram of the match engine of the unbiased, generic and anonymous match engine in accordance with an embodiment of the present disclosure.

FIG. 3 is a block diagram of match engine, negotiation and system components in accordance with an embodiment of the present disclosure.

FIG. 4 is a block diagram of match engine instance and logic components including new user data in accordance with an embodiment of the present disclosure.

FIG. 5 is a block diagram of match engine logic including anonymity match feedback into a relational match logic in accordance with an embodiment of the present disclosure.

FIG. 6 is a block diagram of a partial relational data match and negotiation enable logic in accordance with an embodiment of the present disclosure.

FIG. 7 is a block diagram of an associative relational data match in accordance with an embodiment of the present disclosure.

FIG. 8 are exemplary non-transitory processor-readable storage media instructions executed by at least one processing circuit to perform a sell anonymously service request in accordance with an embodiment of the present disclosure.

FIG. 9 are exemplary non-transitory processor-readable storage media instructions executed by at least one processing circuit to perform a buy anonymously service request in accordance with an embodiment of the present disclosure.

FIG. 10 is a flow chart of anonymous and unbiased match engine negotiations including the matching engine in accordance with an embodiment of the present disclosure.

FIG. 11 is a flow chart of a fully associative database matching search across anonymity firstly and relational data secondly in accordance with an embodiment of the present disclosure.

FIG. 12 are exemplary non-transitory processor-readable storage media instructions executed by at least one processing circuit to perform a buy, sell and trade anonymously service request in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

The following detailed description of the invention and the examples are intended to describe aspects of the invention in sufficient detail to enable those skilled in the art to practice the invention. Other examples can be utilized and changes can be made without departing from the scope of the current invention. The following detailed description is, therefore, not to be taken in a limiting sense.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

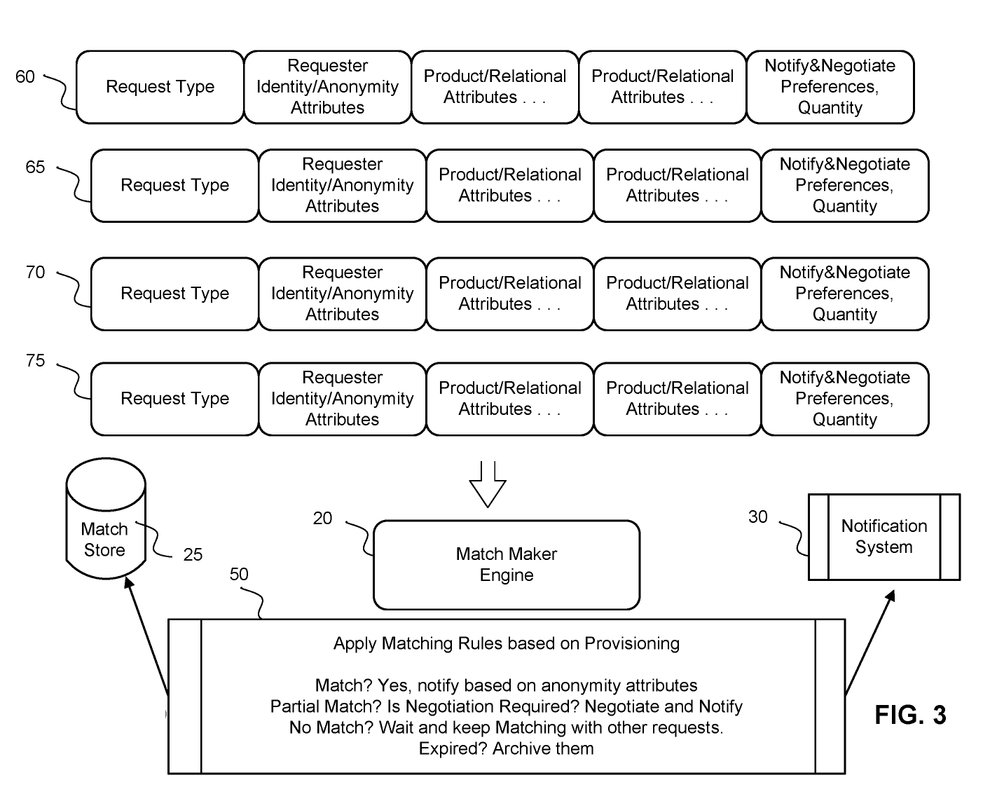

Throughout the present disclosure the term ‘match engine’ refers to circuits, modules, devices, systems and non-transitory processor-readable storage media having one or more instructions which when executed by at least one processing circuit causes the at least one processing circuit to match at least two terms, conditions or fields via a logical comparison thereof. The term ‘blackbox’ is referred to as a proper noun for a name of a proprietary device and system designed and engineered for matching logic and users according to the disclosure. The term ‘RoboNegotiator™ ’ is a protected mark referred to as a proper noun herein and is a disclosed system surrounding and enabling the blackbox matching engine. Furthermore, the term ‘associative,’ ‘semi-associatve,’ and ‘fully associative,’ refer to a logical grouping of relational data domains according to a set of terms and business rules and a monetary consideration a user pays in order to have his or her data considered for as many matches as is logically possible. Relational data is referred to herein as a product or service. Service request is a transaction which comes to the Match engine to be matched with other such requests. Service Requests contain various attributes, and parameters as defined in FIG. 3 for example. Associativity refers to matching data across multiple domains where domains include personal and commercial aspects of a product or service. Multiports refer to instantiated hardware and/or logic which enables concurrent searches on the same data in multiple search threads that run in the disclosed system at the same time.

The present disclosure deals with a private marketplace and provides a SaaS based anonymous and secure, cloud based matching service. Various parties who do not want to reveal their identity until a match is happened with an opposite party based on certain attributes can use the present invention. The present disclosure, also known herein as a blackbox and the associated system including a RoboNegotiator™ and other applications is unique and doesn't deal with just one domain or product line. The disclosed blackbox service is cloud based and uses a general match engine which can act as independent “match engine” for multiple companies and consumers. The purpose of this blackbox is to match interests from two users out of thousands of users in the system anonymously, independently, secretly and concurrently.

According to the anonymous aspect of the disclosure, a single match request by itself will not make any difference to a user's identity and nobody will know what a user is seeking. A user can be assured that he can try to check or explore anything without fear of revealing his or her identity, until someone can and is ready to respond to requests similar to the one posted by the user.

According to an independency aspect of the disclosure in an embodiment, once transactions are posted, match of interest will be done by a software process known herein as a blackbox engine and the RoboNegotiator™ system and not by any company or consumer but as a broker who arranges transactions between two parties and draws a commission therefrom. According to a confidential aspect of the invention, a user can post all kinds of requests in the system and no one will know about the user's attempts to reach someone on the user's terms. This nature of the system allows a user to try wildest things in the system without fearing exposing their identity. Their identity will need to be exposed only if their wildest dream is coming true (there is match in the system) or if something illegal is being done.

According to a concurrent aspect of the invention in an embodiment as disclosed, two transactions are compared for a match ONCE and either they match or they don't match. Concurrent aspects come from processing multiple requests using many threads and in parallel as when they come to the system and are processed. There is no negotiation or retries. On the other hand, in negotiative embodiments disclosed, if two users are trying to close a deal or explore some possibilities with each other, they get one chance. Multiple match requests will be processed simultaneously in different threads, with each thread matching one request. A threshold of negotiation is adjustable so that a primary negotiator offering a product or a service may want to try negotiating only once or ‘n’ number of times with the same user offering a price or consideration for the product or services. The threshold number ‘n’ allows the primary negotiator the ability to be exposed to other better offers via secondary negotiators who are more flexible and more eager to close a deal. The primary negotiator is also enabled to having multiple negotiation threads running concurrently in parallel or running serially depending on his style of negotiation.

The objective of the present disclosure includes mutual terms matching, secrecy, no-spam buying/selling experience, remaining anonymous, keeping identities private/secret, preserving mutual terms via an independent match engine.

The disclosed blackbox Match engine runs a SaaS model (Software as a Service) in the cloud and offers its services to registered and sometimes to non-registered customers. Customers can be independent consumers (retail) or specific vendors offering unique services or products.

Unique Admin UI (user interface) or Provisioning API (published Application Programming Interface) help to configure business rules for some of the match making processes and other attributes (confidentiality, anonymity, security, priority, etc.). These business rules are specific to certain types of service requests (or transactions) and will work on unique pairs of service requests (like LOST×FOUND or SELL×BUY or SEND_INFO×RECEIVE_INFO) or can work on the same kind of requests, LOVE requests for example. These business rules also include specifying what attributes/parameters can be in those service requests when they arrive and which of them are used for successful match decisions. Not all attributes/parameters are needed for a successful match. Similarly, resulting actions on successful matches can be also configured differently for different service request types/transactions. Each service request will have a default expiry period when it no longer needs to remain in the system and can be purged.

Once business rules and service request types are provisioned in the system, the Match engine accepts requests from these customers over Web APIs (SOAP or REST or HTTP/XML derivation). Requests are stored in relational databases but are also stored in big data or noSQL databases too in embodiments. Once validated for completeness, and structural integrity, the match engine will store them in a relational database implemented in Big Data Solution or different noSQL (SQL=Sequel) databases. A database is used for storing incoming service requests, also referred to as transactions, which need to be matched and acted upon in the event of a successful match process and also for secured digital documents which are part of the service requests in some embodiments. In other embodiments digital files aren't needed in a negotiation.

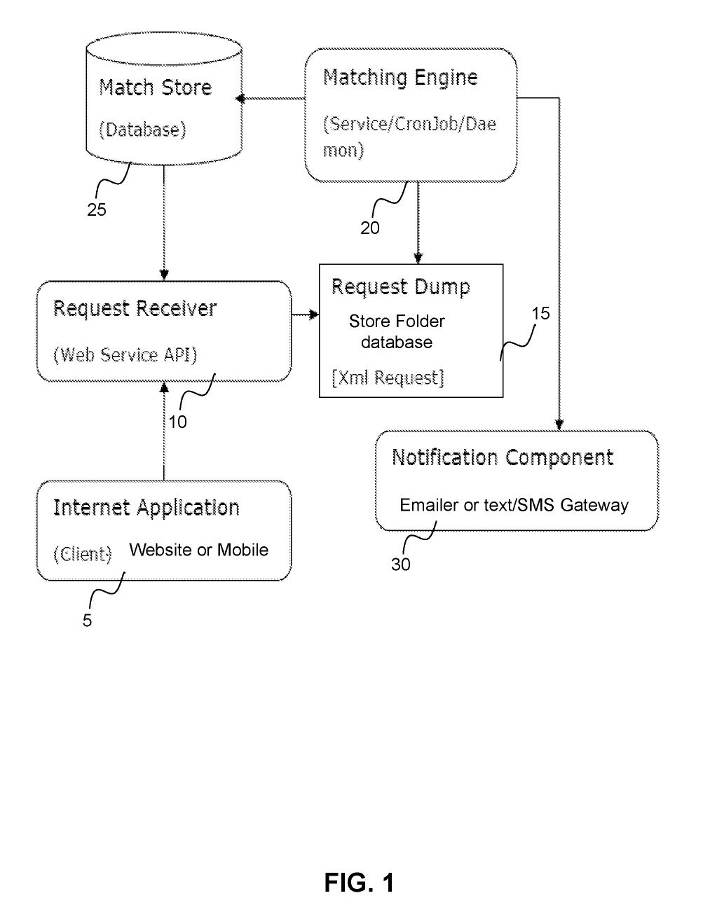

FIG. 1 is a block diagram of system components for an unbiased, generic and anonymous match engine in accordance with an embodiment of the present disclosure. A description of system components of the match engine are as follows. Internet Application 5: A client Application (thin or thick client) interacts with the match engine web service to send a match request and to enquire on a status of earlier sent match requests.

Request Receiver 10: The blackbox match engine will be made available to a client application through the Request Receiver web service. This service can be accessed by a client application over SOAP (simple object access protocol) and over REST API (RESTful web Programming interface). SOAP API receives XML requests which get stored in a folder before it gets added in the database while REST API gets a Key=Value based parameters which get inserted in the database. Request Dump 15: The match request received by the web service will be serialized and stored as xml in a folder. The request is not processed directly, but rather the action is performed asynchronously by an external service. A separate watch module provides scalability for concurrent processing.

Match engine 20: A continuously running service responsible for processing all match requests in FIFO order. While processing, the match request service retrieves request details and compares for a potential match. The matching logic is maintained in a separate xml file or database that is generated while an administrator configures match request types. Match Store 25: The processed match request will be stored in a separate database. This database will contain the matched and unmatched although processed requests. Match logic and rules are stored in separate folders or in a separate table in a database depending on the embodiment implemented per the present disclosure. One seller can have more than 1 item or service to sell, also known as a unit and similarly a buyer may have more than 1 unit (quantity) to buy. The disclosed match engine matches quantity accordingly. Therefore, one seller can be matched with 1 or more buyers and vice versa. Similarly, negotiations are also entertained with multiple parties as long as enough quantity of product or service is available to be matched to negotiating buyers.

Notification Component 30: defined when the match engine finds a match corresponding to a match request. The engine moves the match to a separate table. The match engine invokes a notification component 30 configured for passing the match details. The notification component 30 informs the involved users corresponding to the two match requests. The notification method includes email and is extensible to support other notification means such as text and digital media.

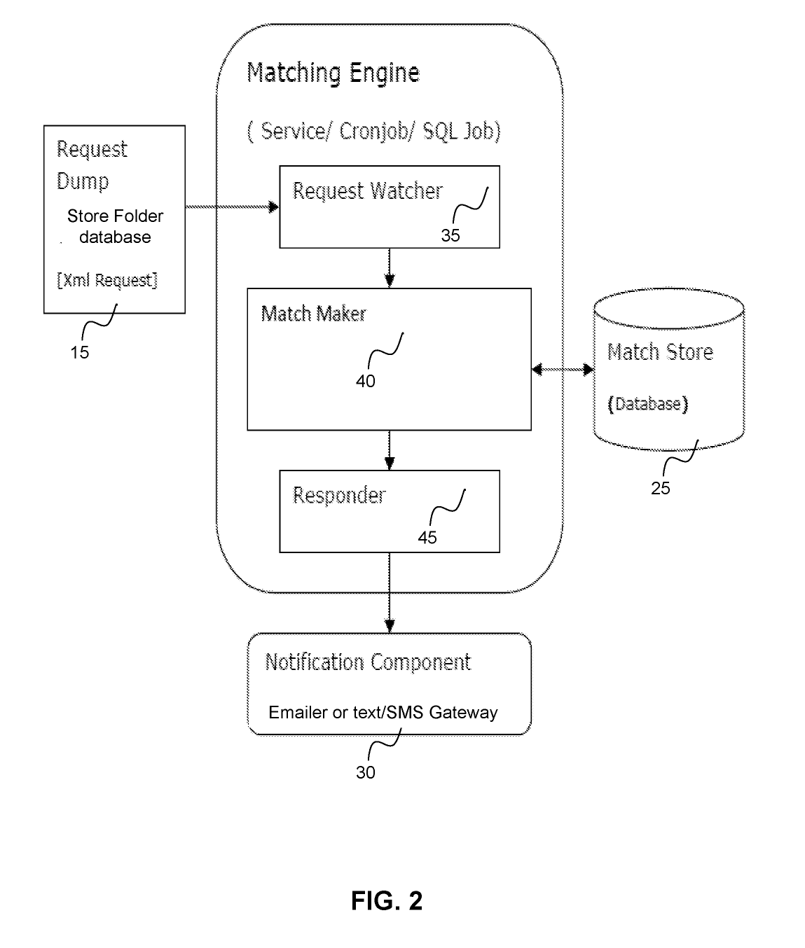

FIG. 2 is a is a detail diagram of the match engine of the unbiased, generic and anonymous match engine in accordance with an embodiment of the present disclosure. The Match engine Component 20 will have three primary components: Request Watcher 35, Match Maker 40 and Responder 45. The basic functionality served by each of the components is described below: Request Watcher 35 is a component module that continuously watches any match request received by the Request Receiver 10 via a Web Service. All match requests received by the Web Service are dumped as xml files in a Request Dump folder 15. The Request Watcher 35 keeps a continuous watch on this folder for occurrence of any new and unprocessed match requests.

As soon as the Request Watcher 35 recognizes a new match request in the request dump folder 15 it notifies the core Match Maker component 40 to process the request. The Match Maker 40 then tries to find a match for the newly arrived request attempting to find its match in an earlier received request. Match rules are already provisioned earlier as part of defining service requests earlier by an administrator and hence those rules are available in xml or database.

If the Match Maker 40 successfully finds a match for the request, it archives the two match requests updating their status as matched in the database 25. Further it notifies the Responder 45 component to update external parties about the found match.

If the Match Maker 40 fails to find a match for the newly arrived match request, it stores the unmatched request for future matching against any new match request, assuming a match will be found over a period of time. The system is configurable to allow a wait of a pending request for a finite or infinite period of time. The Responder component 45 is responsible for informing the involved parties through the Notification component 30 about the found match via email. Other notification medium includes a Dialer or Web Control.

Match request structure is described as follows. Each match request will have a mandatory Request Type attribute. The Request Type attribute is required for categorization of the match request and identify the corresponding matching logic (Match Rule) that should be adopted for finding a match for the given match request. The Request Type attribute will also signify the rest of the attribute that is to available with the match request.

The administrator will have the authority to define new Request Types and their corresponding attributes. The administrator will further be required to define a Match Rule for the given Request Type. Match Rule Structure is described as follows. For each pair of Match Request Type the administrator will define a Match Rule. Effectively each Request Type will have a corresponding Match Rule and an associated Request Type.

There are different system users and their roles are defined. Administrator User is the (default) user highest privilege blackbox user. Its roles includes: Create and configure Match Request; Define Match Rules; Manage other users; Unique Identifier: Username & password. Note: The system currently will support a single administrator user, but shall be extensible to support multiple administrators with different roles.

Now the functions of the client application are described as follows. Each client application having access to the Request Receiver Web Service will be uniquely identified by the system. This will allow the possibility of authenticating the client application and preventing spam attack. Furthermore, limiting a client access to a product or a service is included by coding restrictions to a limitation Type or an identifying Number of requests acceptable from the client, or a priority of request.

The End Users or individuals accessing the matching service through a client application can also be maintained by the system. Unique Identifier: Username & password. Basic Concept of Core engine is described as follows: Core part is Universal, General Purpose. The disclosed Smart Match engine takes transactions asynchronously over the web via distributed computers and matches them 1:1 or 1 to many. Every transaction has a specific life and if there are matching transactions within its life, two entities go ahead and do the specific business outside the disclosed engine. The system charges them per transaction matched and per a life of their transaction in the system. Match Parameters, Resulting Action all are part of transaction service requests. Match rules are already provisioned via an administrator.

FIG. 3 is a block diagram of match engine, negotiation and system components in accordance with an embodiment of the present disclosure. The components include a first line 60 for a first user includes data and instruction circuits and modules including a request type, a requester identity/anonymity attribute, product/relational attributes and notification and negotiation preferences in quantity. A second line 65 of the same format, attributes and preferences for a second user, a third line 70 for a third user and an nth line 75 for an nth user are depicted. The match engine 20 matches a request type and related attributes and preferences according to matching rules 50 and stores a result in the match store 25 and performs a notification 30. The match rules 50 determine a match hit and notification of anonymity attributes. The match rules 50 are also based on a partial match hit or event for a possible negotiation and notification. The match rules 50 include a no match event where a provisional match event may occur over time before an expiry and an archiving of data and information.

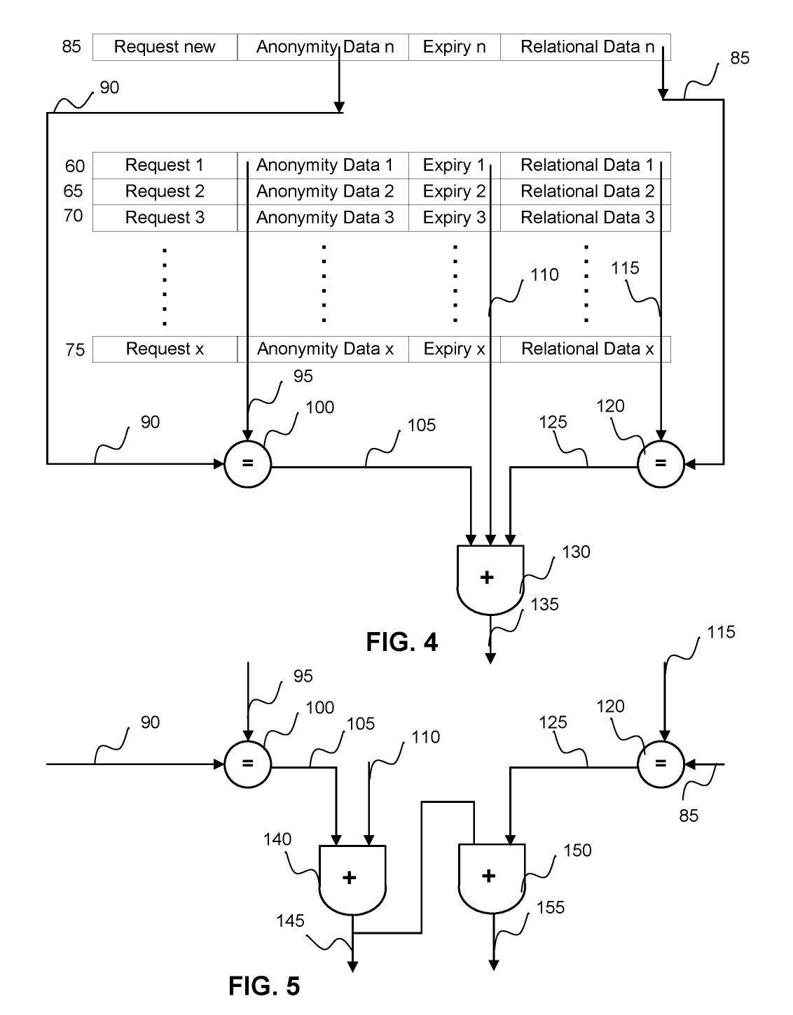

FIG. 4 is a block diagram of a match engine instance and logic components including a new user data in accordance with an embodiment of the present disclosure. The depicted instance represents a single ported comparison thread. Other instances are flat in a hierarchy of the multiported and instantiated system. The first line 60 for a first user also includes the expiry data for the line given at time of creation according to a monetary consideration from the user to the system. The new request line 85 for a new user also includes the request type, identification and anonymity data and relational and product data and negotiation instructions (not shown). The new user anonymity data 90 is matched with all the anonymity data of the other users or clients as represented by the wire or connection 95 to the match circuit 100. Another wired or connected port on the anonymity data 1, 2 and 3 is not depicted for illustration simplicity but would make a connection with the anonymity data 1, 2 and 3 from respective lines 60, 65 and 70 into another match circuit/logic (not shown). The output 105 of the match engine circuits/logic 100 is received at AND circuits/logic 130 with the ‘wired or’ expiry 110 of all prior users as indicated by wire or connection 100. The third relational data is wire or connection 115 of relational data 1, 2 and 3 from lines 60, 65 and 70 respectively. The new user relational data 85 is matched with all the relational data of the other clients as represented by the wire or connections 110 at match engine 120. The output 125 of match circuits/logic 120 is received at the AND circuits/logic 130. In the event an anonymity match hits and a relational match hits during an active expiry (ie, not expired), the output 135 is active and indicates a match and notification of the new user there is a match.

FIG. 5 is a block diagram of match engine logic including anonymity match feedback into a relational match logic in accordance with an embodiment of the present disclosure. Similar reference numbers to those of FIG. 4 indicate same and similar components with the distinguishing feature of an additional AND circuit/logic 150 and anonymity match wire or connection 145 coming from the AND 140 of the expiry 110 and the anonymity match 105. The new output 155 is logically similar to the output 135 but occurs in a separate stage to enable the anonymity match 145 result to be used for notification to respective users of an identification and anonymity match independent of the relational data match.

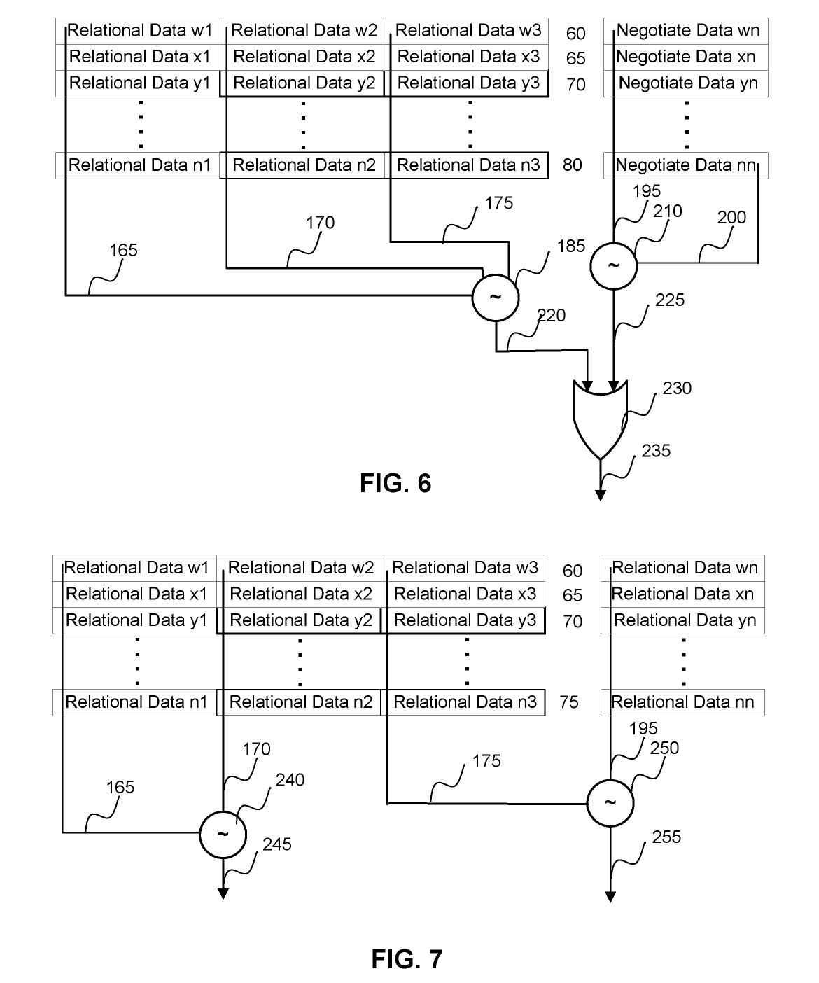

FIG. 6 is a block diagram of a partial relational data match and negotiation enable logic in accordance with an embodiment of the present disclosure. Lines 60, 65 and 70 are shown having 3 sets of relational data and one set of negotiation data wn, xn, yn and nn. Wires or connections 165, 170 and 175 feed into the partial match circuit/module 185. Negotiation data 195 and negotiation data nn 200 for a new user, feed into the partial match circuit/module 210. The outputs 225 and 220 feed the OR circuit/module 230 which is also implemented by non-transient computer implemented code or instructions. The output 235 is therefore an indication of either the relational partial match 220 or the partial negotiations match 225 to signal a start of negotiations between at least two users.

FIG. 7 is a block diagram of an associative relational data match in accordance with an embodiment of the present disclosure. A first associative set of relational data includes relational data input through 165 to a partial match circuit/module 240 and the relational data input through 170 to the partial match circuit/module 240. The second associative set of relational data includes relational data input through 175 to a partial match circuit/module 250 and the relational data input through 195 to the partial match circuit/module 250. Respective outputs 245 and 255 indicate a match or a partial match of the first or the second set associative data with a new user's data (not shown).

For instance, a semi-associative match is one where a user is looking to buy a sports car and is single and a matching user is also single and also looking for someone who can afford a sports car. The relational data ‘sports car’ and ‘single’ are associated in a match and other relational data are not associated. A two way set associative data match is one where ‘sports car’ and ‘single’ are a first associated set of data but also ‘Houston location’ and ‘running partner’ are a second associated set of data. A fully associative match is one where all the data of a user is available to match all the data or partial data domains of another user depending on if both parties are fully associative or if one is simply semi-associative or fully associative. Associativity of relational data domains is an aspect of the present disclosure that is used to distinguish higher paying users. Associativity refers to matching data across multiple domains where domains include personal and commercial aspects of a product or a service.

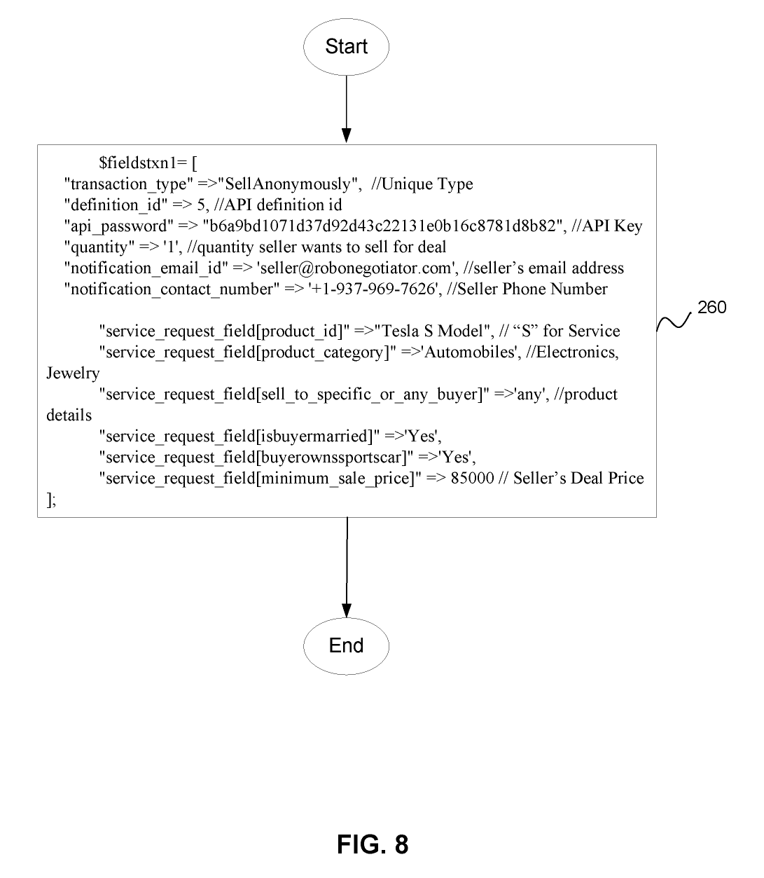

FIG. 8 are exemplary non-transitory processor-readable storage media instructions executed by at least one processing circuit to perform a sell anonymously service request in accordance with an embodiment of the present disclosure. The sell anonymously exemplary service request 260 is communicated to the blackbox engine, also known as the RoboNegotiator™ system according to an embodiment of the present disclosure. The exemplary code defines an actual Service Request sent to the back end Match engine. The present service request is from a seller who wants to sell a “Tesla S Model” to any buyer who is married and owns a Sports Car. The Seller's minimum sell price is $85000. Any offered price above that, will match on price terms but the deal won't perfect unless the anonymity aspects of the deal also match. In other words, Seller has 1 car to sell and the seller provides his or her contact details ONLY IF there is a match. This request remains hidden in the disclosed database unless there is a matching request from a seller matching these criteria.

$fieldstxn1= [

```
  ″transaction_type″ =>″SellAnonymously″, //Unique Type
  ″definition_id″ => 5, //API definition id
  ″api_password″ => ″b6a9bd1071d37d92d43c22131e0b16c8781d8b82″,
//API Key
  ″quantity″ => ‘1’, //quantity seller wants to sell for deal
  ″notification_email_id″ => ‘seller@robonegotiator.com’, //seller's
  email address
  ″notification_contact_number″ => ‘+1-937-969-7626’, //Seller
  Phone Number
        ″service_request_field[product_id]″ =>″Tesla S Model″,
        // “S” Service
        ″service_request_field[product_category]″ =>‘Automobiles’,
//Electronics, Jewelry
        ″service_request_field[sell_to_specific_or_any_buyer]″
=>‘any’, //product details
        ″service_request_field[isbuyermarried]″ =>‘Yes’,
        ″service_request_field[buyerownssportscar]″ =>‘Yes’,
        ″service_request_field[minimum_sale_pricer]″ => 85000
        // Seller's Deal
```

Notice above that the transactional type is ‘sellanonymously,’ and the relational data types above including ‘isbuyermarried,’ and ‘buyerownssportscar,’ are both considered so that a match is fully associative across data types. The disclosed data rules and services can be used in a relational database or used in a non-relational database according to the user's matching needs and negotiation requirements.

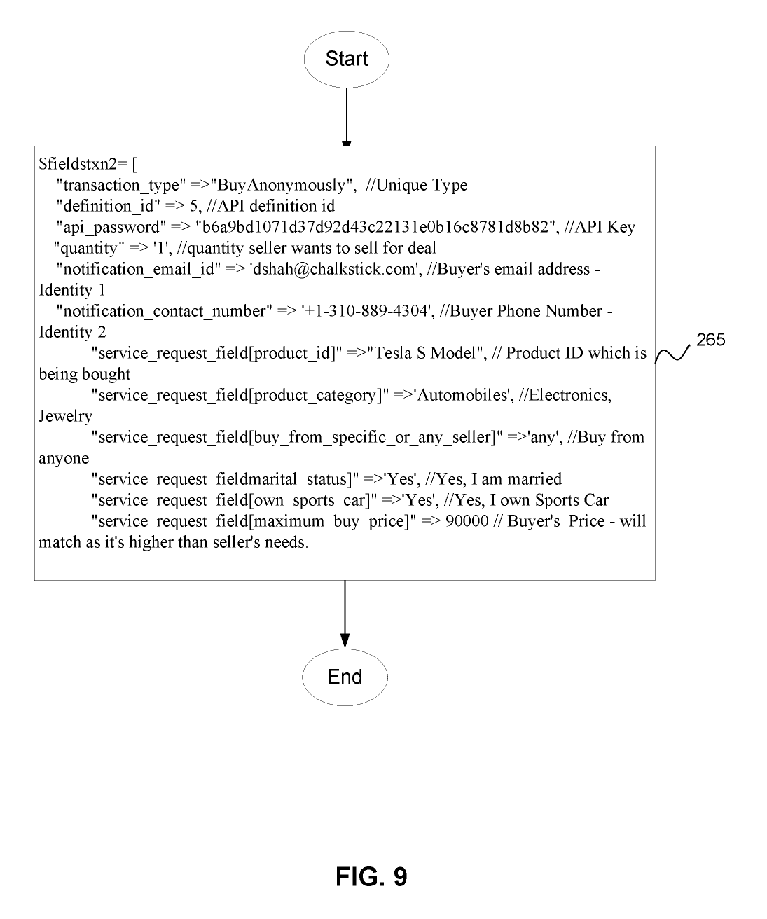

FIG. 9 are exemplary non-transitory processor-readable storage media instructions executed by at least one processing circuit to perform a buy anonymously service request in accordance with an embodiment of the present disclosure. This exemplary code presents a sell anonymously service request 265 to the blackbox engine, also known as the RoboNegotiator™ system. The following exemplary code defines an Actual Service Request sent to the back end Match engine. The present Service Request is from a buyer (website visitor) who is offering his price. The Buyer wants to buy “Tesla S Model” from any seller. Buyer provides his/her marital status (Yes or No) and also if he owns a sports car (Yes/No). The Buyer's maximum offer is 90,000, any selling price below that amount will match. The Buyer has 1 car to buy and buyer provides his contact details ONLY IF there is a match. The request will remain hidden in the disclosed database unless there is a matching request from the buyerer matching these criteria as defined in code below.

$fieldstxn2= [

```
  “transaction_type” =>“BuyAnonymously”, //Unique Type
  “definition_id” => 5, //API definition id
  “api_password” => “b6a9bd1071d37d92d43c22131e0b16c8781d8b82”,
//API Key
  “quantity” => ‘1’, //quantity seller wants to sell for deal
  “notification_email_id” => ‘dshah@chalkstick.com’, //Buyer's
email address - Identity 1
  “notification_contact_number” => ‘+1-310-889-4304’, //Buyer
Phone Number - Identity 2
        “service_request_field[product_id]” =>“Tesla S Model”,
// Product ID which is being bought
        “service_request_field[product_category]” =>‘Automobiles’,
//Electronics, Jewelry
        “service_request_field[buy_from_specific_or_any_seller]”
=>‘any’, //Buy from anyone
        “service_request_fieldmarital_status]” =>‘Yes’, //Yes,
        I am married
        “service_request_field[own_sports_car]” =>‘Yes’, //Yes,
I own Sports Car
        “service_request_field[maximum_buy_price]” => 90000
// Buyer's Price - will match as it's higher than seller's needs.
        ];
```

A Send First REST API for “SellAnonymously” transaction is followed by a ProcessRestOperation(fieldstxn1). A Send Second REST API for “BuyAnonymously” included in the pair so they match or at least initiate a negotiation, ProcessRestOperation(Sfieldstxn2).

Service request types include types include ‘lost n found, sell n buy, lock n key, data push n data pull, date seek n date find, interview n feedback, social event n find’ applications. Depictions include a Bluetooth handset sell n buy, a travel sell n buy, a data push n data pull, and a housing rental sell n buy requests.

Now, consider following scenarios which are slightly distinguishable over used traditional Internet matching services.

(a) John is interested in dating Nancy, but only if Nancy has similar interest in John. However, both do not want to take initiative to inform each other about their intentions independently. They want someone else to mediate for them.

(b) Delta Airlines is ready to discount heavily on its route from LAX to JFK for a given date/flight as long as it doesn't get published to all and it doesn't set up precedence. John is ready to buy an air ticket for the same flight if his terms for the fare are met independently, but not after Delta knows price named by John.

(c) A house with a given MLS# is for sale and everyone knows about the market value for the house based on publically available research. The Seller and a Buyer want to close on a deal without going into lengthy negotiation which might waste some time.

(d) John has written a living will and wants to secure it in a place where it is accessible only to his daughter Nancy and only at a time John wants Nancy to access it. John may update the will meanwhile and he wants Nancy to be able to see the latest and greatest when the time comes.

(e) John is living on a budget and wants to organize his monthly expenses by putting a limit on each type of expenses he is ready to commit Vendors can get John's business only if they are also offering the items for which John put in his budget if the items fit within that budget.

(f) A plumbing company has decided to discount heavily on their service rate for specific hours. However, they don't want to publish the cheapest rate as it will set-up a precedence they don't want to perpetuate. John needs a plumber and is looking for an inexpensive rate and he is OK to get a plumber whenever a plumber is free at his cheapest rate. This is similar in some sense as in the airfare example (b) above.

### Example 1

‘Lost n Found’ Service. A company tracking lost items or tracking a person who lost an item, sends a LOST request to the disclosed match engine. The requests describes what the item is, where it was lost, when it was lost and potentially unique characteristics about the item including but not limited to an URL showing the image. At a later stage, another company/person who finds the item puts a FOUND request in the match engine describing some of the parameters or characteristics which match from the original request such as an URL for example, the city where it was lost/found, etc.). The disclosed match engine matches the ‘LOST’ request with the ‘FOUND’ request and reveals the identity of each other including but not limited to their identity, email address, phone number, etc.).

For instance, let's say John lost a Timex watch in Thousand Oaks city and Nancy found that watch in a park in Thousand Oaks city. To help these two individuals to reach to each other, the disclosed blackbox match engine can help in the following way.

Nancy puts a transaction ‘FOUND’ identifying herself (User1=Nancy, User2=*) as a recipient of the ITEM_TYPE=“WATCH” with additional attributes LOCATION_CITY=Thousand Oaks and ITEM=“Timex”. If John also puts a transaction ‘LOST’ identifying himself (User1=John, User2=*) with ITEM_TYPE=“WATCH” and LOCATION_CITY=“Thousand Oaks”, the disclosed system will compare the transaction types (LOST×FOUND), followed by two names (incl. wildcards) followed by “LOCATION_CITY” followed by ITEM_TYPE and sees that there is a match.

### Example 2

Digital Safe Deposit Vault. A parent is leaving some confidential and secret digital documents including but not limited to a Will, financial accounts, login/passwords for various websites, etc. to their son/daughter. The parent would put a transaction ‘LOCK’ to a system along with attachments, secret documents along with a potential key and the identity of a son/daughter who would retrieve it in the future. At a later stage, the son/daughter enters a ‘KEY’ transaction with identity, and further key information to unlock the confidential and secret information. The disclosed system matches the LOCK and KEY transactions and reveals the secret documents to the respective son/daughter.

In a similar example or use case, John wants to send a file “MyData.doc” to Nancy only. John and Nancy both have user id or email addresses in the system so it can uniquely authorize, identify and associate them. However, John doesn't want to send his file directly to Nancy. John wants this data to be available to Nancy only if Nancy has shown interest to get a file from John even though she may not know his name.

In order to get his file into Nancy's hand, the following things are performed by the disclosed blackbox service.

(a) John puts a message, also referred to as a transaction, of type “DATA_PUSH” for Nancy in the system for example. The actual data is “MyData.doc”. John also can optionally define a Lock and a Key to enable Nancy access to his information but here he chooses not to put that limitation.

(b) Nancy puts a message of type “DATA_PULL from John in the system for example. If John put a lock and key on his information, Nancy must have the access key in to the system.

The disclosed blackbox matching engine will parse both of these messages in the background and at some regular interval to see that two users match in the source and destination of their messages. When Transaction Types are opposite to each other or are part of pair of responses, it is a MATCH event.

On a match event, the blackbox will see if Users asked for confirmation before exposing the data and identity of each other or not. If identity confirmation is requested, the System will send a confirmation message to John and Nancy individually mentioning that a MATCH has occurred. The system queries the two parties to see if it should go ahead with exposing the identity of each other and their data in their respective ‘MyData.doc’ file. If one of them or both of them accept the confirmation, the system will expose the data depending on the restriction imposed.

Exposing the secret data or a user's identity on a match event can happen either through email, text, and other media or through web access by two users, persons or parties.

### Example 3

Real Estate Transaction. There is a unique URL describing a house in a given city and the seller/owner of the house puts a SELL transaction describing the unique URL, minimum sell value he or she would agree to, conditions, etc. in this transaction. A Buyer asynchronously puts a BUY transaction for the same URL (unique) along with his identity (email or phone#) with the maximum price he is committed to pay for the house. The disclosed blackbox matching engine compares and matches SELL×BUY transactions for same URL (unique) and reveals the identity of buyer and seller to each other unless either party wanted a confidential sale. There is a provision for a seller who wants to meet a potential buyer to maintain a certain character of a neighborhood.

### Example 4

Car Purchase. A unique URL, for example http://www.blackbox.com/negotiate/item101.htm contains all the information regarding John's 2001 Honda Accord car he is trying to sell. Nancy is interested in buying his car after reviewing the URL and both want to negotiate through blackbox. John will put a SELL transaction in the system for ITEM=http://www.blackbox.com/negotiate/item101.htm and other users will be * so anyone can bid. John will put price=“>16000” in the message.

Nancy puts a BUY transaction for the same or similar item and URL above from Nancy and other user=*(any seller) and puts price=“<16500”. The system will match these two requests, BUY×SELL, same or similar ITEM and same set of users with their price also matching and will reveal the identity and price to both the users.

Regarding New Car Transactions/Dealerships—Most new car buyers are now trying to get away from a car dealership. A new car dealership negotiation is fraught with games and emotions not everyone is willing to play. With a unique VIN# mechanism in place to identify a vehicle, dealership can offer a final negotiation via the blackbox for the customer who is about to leave the dealership.

### Example 5

Dating a Colleague, Classmates or a Friend. Two colleagues/co-workers, classmates or friends like each other but cannot openly propose a romantic or physical relationship to the other. Both of them put a LOVE transaction for each other into the disclosed system. It one person doesn't perfect a LOVE transaction in the match engine, a match is not possible on all terms when the matching rule=identity of each other (email or phone#). On a successful match event, the system reveals party identities and introduces each other as a third party mediator.

For example, let's say John and Nancy know each other and are silently interested in each other for date purposes or for a physical relationship possibly leading to love. Assuming they are shy and not able to expose their intention to each other directly, both of them will put a message into the blackbox matching engine knowing that they will not be exposed until a mutual interest matches from both of them. John puts a transaction “DATE SEEK” from John for Nancy. Nancy puts a similar “DATE SEEK” transaction from Nancy for John and the disclosed System independently matches these intentions and reveals the identity/interest to each other on a match event.

In the examples above, it is important to observe that the MATCH criteria changes depending on transaction types, DATA_PUSH×DATA_PULL. The match engine compares the transaction types and compares users and a match occurs. In a second use case, a transaction type, users with wild card consideration, LOCATION, ITEM_TYPE are used for a MATCH event. In some embodiments, the disclosure can also go one more levels to compare “ITEM=Timex” in to mix for full associativity.

### Example 6

Goods/Products/Items, 10 items special deal—Seller has 25 items including JABRA headsets for example and puts a special deal for 10 customers into the disclosed match engine. A ‘SELL’ transaction with a unique URL showing Jabra handsets with a request to match 10 customers with a deal price. Customers interested in same and similar items come to visit seller's page and puts ‘BUY’ transactions for the items with their offering value. If customers put more value than the deal requests and if the deal is still available, they get matches otherwise their transaction doesn't match and gets voided. On a match event, the system matches SELL×BUY transactions one offered item to 10 purchases (1:10) and reveals the identities of all the parties to each other.

### Example 7

Airline/Hotel Deals. Southwest Airlines puts special deals for specific flights including routes, dates, origin and destinations with a minimum fare for first 20 people. Consumers interested in checking their luck puts their bids into the matching engine and on successful match, these consumers get special discounted price/code which they can apply on Southwest website. This same mechanism can be applied to a hotel deal for a certain location, specific nights or other vacation/travel package deals.

### Example 8

Facebook—Know your real friends. Know your best 10 friends through the disclosed matching engine immediately. One might have 500+ friends on Facebook but how many consider you their best friend? The disclosure makes it a matter of matching friends who care for you through the blackbox matching engine.

### Example 9

Hiring Decision through 5 interviews for a best candidate. A typical corporate world hiring decision includes a group wrap-up at the end of a day of interviews to discuss the outcome. There are at least two problems with this—(1) waste of 30 minutes at least per interviewer and (2) initial feedback from some interviewers dictate the outcome as later interviewers tend to change their tone/answers/feedback in a group set-up. One solution—at the end of an interview, all interviewers send their feedback against 5 pre-defined parameters to blackbox. blackbox matches and consolidates feedback and sends a report to Human Resources. Based on success criteria defined for this match, Human Resources acts on it or ignores the candidate completely.

### Example 10

Company Execs & Employee Feedback. Successful companies are transparent and seek input from their employees in order to act on important issues brought to their attention. Most employees do not give “honest” feedback in a group or an open forum set-up and hence management has a hard time knowing reality. blackbox can help here where executives are seeking feedback and where employees have provided feedback. Chief Executive Officers can also seek input on specific Vice President, Chief Technology Officer, Chief Financial Officers and high level positions by putting a match transaction into blackbox.

Other examples includes Secured Uni-Directional Data Transfer, Salary Negotiation, Mobile Apps—using MSIMDN# automatically to send each other message, anonymous interests, Venture Capital Activities—Negotiation on Equities, Company/Date Finder, Vanpool/Carpool Partner finder. Social convenience matches are also compared, such as, “does anyone want to go to Veggie Gill, Thousand Oaks with * on 14th Feb?” If there is someone who is interested in the same, a match event happens. Similarly, vanpool/carpool finder service can be also offered using the disclosed match engine, No Spam=private experience of information exchange.

No one needs to know who got what deal and who offered it. Scheduled/Delayed/Password based File Transfers are also performed such as, “Wanted to send this file to my IP Consultant only when he sends me NDA. Post a file for a given password for IPJuvarez in blackbox so he can retrieve it based on a password first user tells him verbally once NDA is received. The first users doesn't need to be on my computer when this happens.”

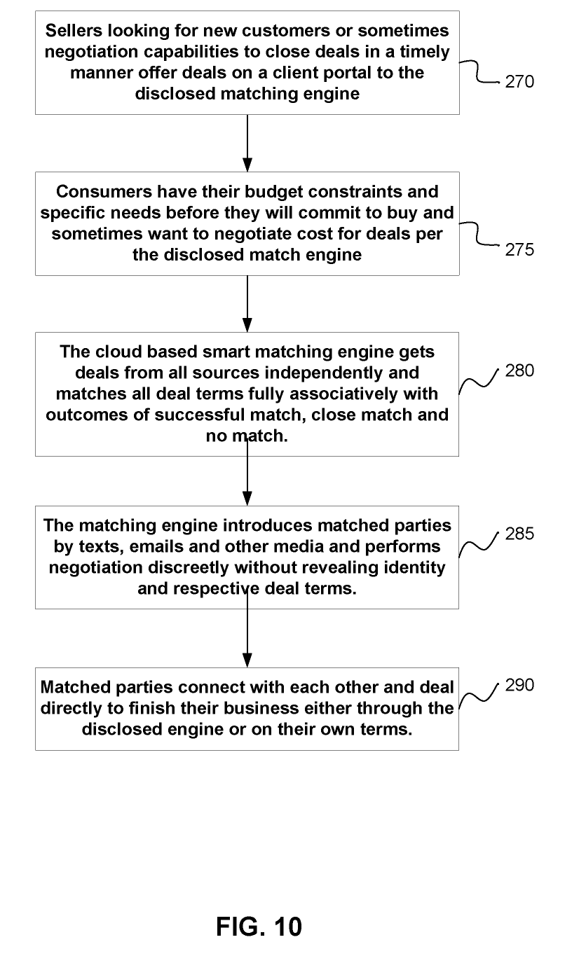

FIG. 10 is a flow chart of anonymous and unbiased match engine negotiations including the matching engine in accordance with an embodiment of the present disclosure. Reference number 270 includes sellerslooking for new customers or sometimes negotiation capabilities to close deals in a timely manner offer deals on a client portal to the disclosed matching engine. Reference number 275 includes Consumers entering their budget constraints and specific needs before they will commit to buy and sometimes want to negotiate cost for deals per the disclosed match engine. Reference number 280 includes the cloud based smart matching engine getting deals from all sources independently. It also includes fully associative matching deal terms with outcomes of successful match, close match and no match. Reference number 285 includes the matching engine introducing matched parties by texts, emails and other media and performing negotiation discreetly without revealing identity and respective deal terms. Furthermore, reference number 290 includes matched parties connecting with each other and dealing directly to finish their business either through the disclosed engine or on their own terms and through their own devices.

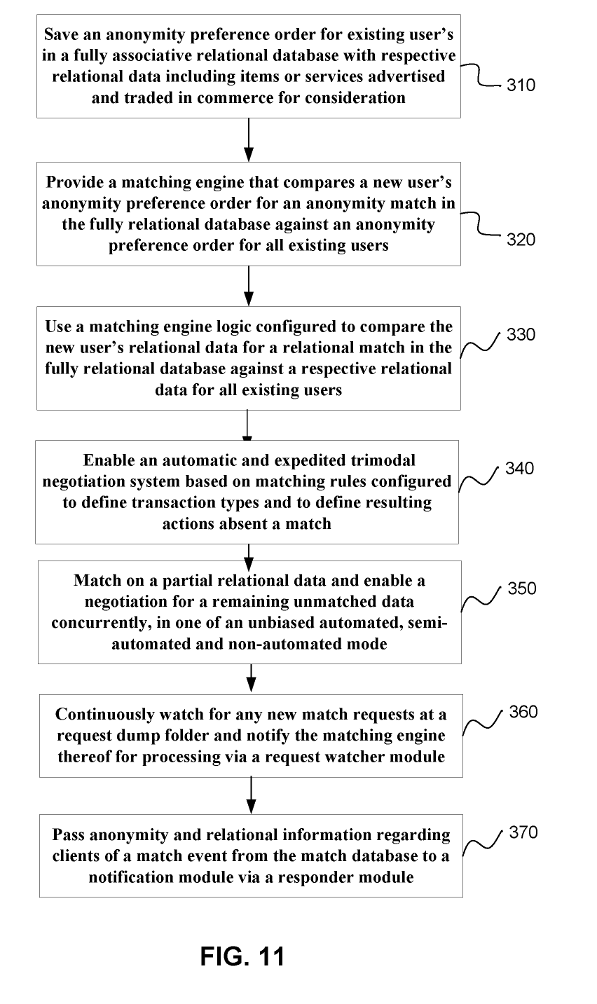

FIG. 11 is a flow chart of a fully associative database matching search across anonymity firstly and relational data secondly in accordance with an embodiment of the present disclosure. Reference number 310 includes providing a fully associative and relational database for saving an anonymity preference order for a plurality of existing user's with respective relational data including items or services advertised and traded in commerce for consideration. Reference number 320 includes providing a matching engine configured to compare a new user's anonymity preference order for an anonymity match in the fully associative and relational database against an anonymity preference order for all existing users. Reference number 330 includes using a matching engine logic configured to compare the new user's relational data for a relational match in the fully associative and relational database against a respective relational data for all existing users across relational data associated types. Reference number 340 includes enabling an automatic and expedited trimodal negotiation system based on matching rules configured to define transaction types and to define resulting actions absent a complete or perfect match. Reference number 350 includes matching on a partial relational data and enabling a negotiation for a remaining unmatched data concurrently in one of an unbiased automated, semi-automated and non-automated modes. Reference number 360 includes continuously watching for any new match requests at a request dump folder and notifying the matching engine thereof for processing via a request from the watcher module. Furthermore, reference number 370 includes passing anonymity and relational information regarding clients of a match event from the match database to a notification module via a responder module.

The match engine code, heuristics and algorithms enable matching items and products between buyers and sellers trying buy/sell same or similar things and not something else. An ideal hosting space is provided with item description/image/info (like Groupon deals) via proprietary matching engine code. Requests from sellers and buyers are put into the system initiated from specific web sites so there is no confusion on an item. Every request put into the system by a Seller is implemented in code that conveys that there is a deal in blackbox for them to try. However, there is no guarantee of a match up though.

Personal Matches involving love affairs and dating requires identifying a unique person and hence Facebook page integration could be a best approach for matching. Social media cooperation across media and across platforms is provided in the system and code.

Airline Deals showing deals on their web page, www.southwest.com for example, are enabled by the disclosure for buyers visiting their sites to initiate requests for a match against Southwest's requests/deals.

### System Requirements

System Requirements are discussed in detail below. There are different major Components: blackbox engine with DB/File Access published with API (application programming interface) to take messages. This is a large amount of focus and time in designing and implementing and is the heart of the system. Scalability to thousands of transactions in a system, Concurrency (Multiple transactions are being matched at the same time), Performance, Security (information from one transaction do not go to others, no one can retrieve a transaction or data from the system, etc) are some of the key requirements.

Sample Applications per above are integrated with the disclosed blackbox engine. Applications demonstrate that blackbox has an open API (Web 2.0) and can take and publish information. Applications are designed from use cases described above. More and more use cases are implemented using blackbox engine.

Admin UI (user interface): This will be used only internally by a blackbox Administrator. Visibility is provided into which messages are stored in the blackbox at a given time along with their types and status. This is useful for demo and debugging purposes.

### Data and Control Flow

Control Flow of the system is as follows.

(a) When the system comes up initially, it is in a blank state. The system doesn't yet recognize any transaction pairs.

(b) The web API first configures the pair types along with matching criteria which are going to be used by a given application (external web app). Alternatively, an Admin User configures the types of Transaction Pairs which must be matched along with Matching Criteria for that pair (Lost Vs. Found, Sell Vs. Buy, etc).

(c) Various transactions/messages come from published APIs with all key details including user info, access info, data and other relevant attributes/pairs which are posted by various users from various web sites. If system is not configured for the given transaction type yet, an appropriate error message is returned.

(d) Transactions are validated against published schema (DTD document type definition) and users as part of a message authenticated against some DB (database). Once everything is checked and cleared against rules, a transaction is stored in the system with a time stamp. If there is external data associated with a message such as a file attachment, the file will be saved as well.

(e) Match engine process(es) in the background match various transactions in the system including source Vs. destination users, transaction type pairs and one or more attributes which must be matched before two transactions generate a match event.

(f) If no matching transaction occurs in the system, compare the next transaction for a match. Status indicators will remain in WAITING.

(g) If there is a potential match but transactions didn't match completely up to and including acceptance of a failed condition, status indicators for these transactions change to “PARTIAL MATCH.”

(h) Once transactions are matched completely between two users along with acceptance conditions, a transaction will be checked and compared for notification to both the users before exposing the content of the messages. If so, users are notified about the match by email, text and other media. Users are allowed to retrieve data from the system when both users agree to reveal the terms and content of the transactions. Alternatively, depending on a delivery preference defined by a source user, the destination user can be automatically notified about the data present in the system. Until both users access the hidden data, a transaction will remain in the “MATCH” status.

(i) Once data for matched transactions are revealed/published to both users, the transaction status of the match changes to “ARCHIVE.”

(j) Each transaction will have an “expiry” attribute, at which time a transaction is no longer valid and can be purged from the system. If an expiry is not explicitly defined, the disclosure assumes one year from the entry date as a default expiry date.

(k) Additional threads keep scanning the fully associative database for expired transactions and purges them from the system.

Other general requirements of the system are:

(a) Matching engine is a back end part so it is developed as an independent algorithm/process which takes any number of transactions from Data Base storage and processes them. In a typical world, more of these application servers/processes are scanning thousands of transactions posted to the site by thousands of users processing in real time or delayed fashion.

(b) Messages are always coming from trusted sources such as external partner websites. Users ID listed in the transactions are blackbox subscribers or partner subscribers and hence are authenticated as UserIDs against a database.

(c) In real time, there are many MATCH ENGINE PROCESSES which access the match database simultaneously including one process for each transaction pair type so scalability, sharing records and locking are also required.

(d) File Upload of data which are part of a matching transaction remain in a flat file system—on the disk, but no one is able to access those files directly. Only a matched user gets access to matching files through the blackbox GUI/Service.

(e) Ability to encrypt and decrypt data on retrieval is included in embodiments. Secure applications looking to use blackbox in a safe deposit vault mode use this feature.

(f) blackbox is an algorithm/engine or a backend module which has access to SQL DB (structured query language data base) and file systems to store documents and data coming from within the blackbox.

(g) blackbox receives transaction requests, also referred to as Messages from outside the system and stores them and processes them in a compare for a match. Messages have various parameters/attributes as follows.

Transaction Type==Examples=Lost,Found,Push,Pull,Sell,Buy

Source User=User who posted the transaction (assume some kind of ID which will be authenticated from some database). Each User ID will have a corresponding email address which can derived from the same database.

Target User=User who this message is targeted for (*=match with anyone). The asterisk is a character that will match any character or sequence of characters and can have any value and any property.

Additional parameters have attributes with some values. Embodiments may also have data (files) depending on transaction types. These parameters/values will be used for a matching algorithm.

Few additional possibilities are there for each transaction/message:

(a) User may put a Lock and Key so information in the system gets to another user only if same lock and key (username/password kind) were provided by other user. This feature can be useful when the system acts as a safe box (online vault).

(b) There could be an expiry attribute to the system and hence a message may not reach another user if another transaction for matching comes after the message has expired. This will prevent the system from overflowing from all sorts of transactions which will never match and are best aborted. Also, this will allow faster processing times and bound deals and interests from two fresh users.

(c) There could be a possibility that User1 and/or User2 do not want to expose themselves even on a MATCH event which occurs between their messages. They may prefer that system confirms the match first and asks them before letting System reveal each other's identity. Email approval will trigger data delivery from the system in such cases.

(d) User1 may want to send data to one or more users and hence he or she may use a “*” wild card so anyone with matching transactions for User1 can retrieve respective data.

(e) Similarly, a transaction can come anonymously from user1 and hence user1 can choose “*” for the source user (person who posted the data) and hence another user doesn't need to know where the data is coming from. User2 will seek data from * so he doesn't know who posted the data. Some use cases and features listed above may not make sense in practical ways but they are being provided to enable some of the applications in the future.

Match engine status includes ‘available,’ ‘a full match,’ ‘a partial match,’ ‘in negotiation,’ ‘Queued’ and ‘archived’ or perfected. A ‘hidden’ status provides protection for a deal in negotiation but as mentioned above, without a hidden status a deal in negotiation is open to a better offer at any time. All parties have the ability to call off a negotiation in progress or to stall a negotiation.

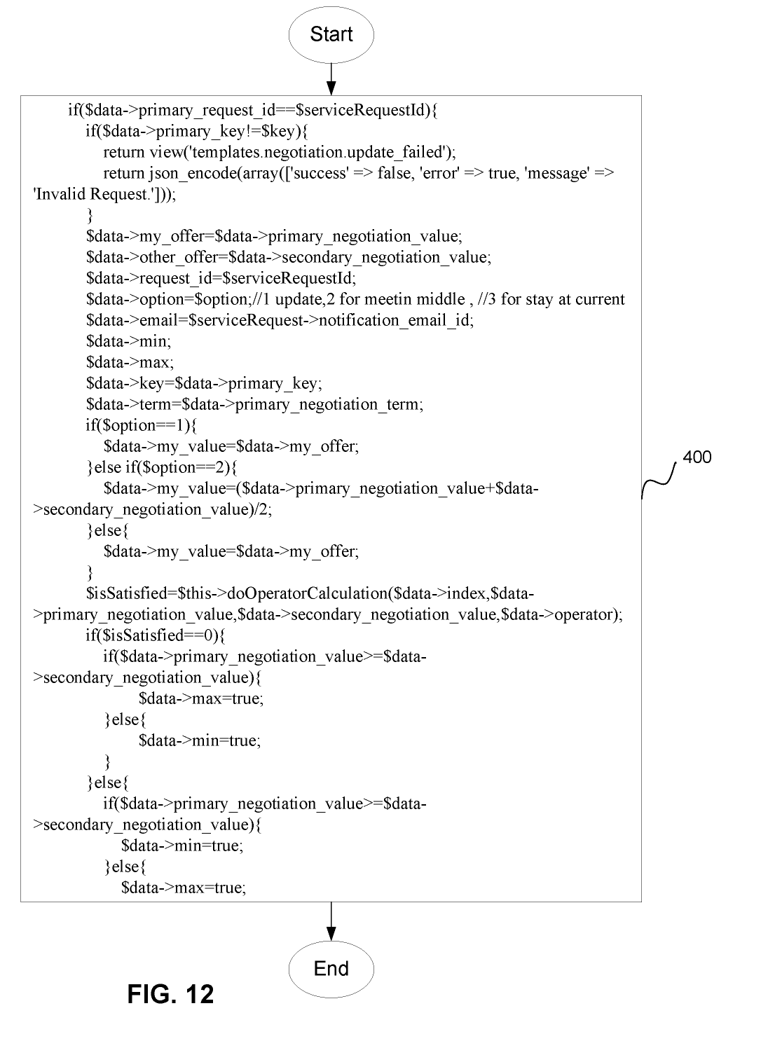

FIG. 12 are exemplary non-transitory processor-readable storage media instructions executed by at least one processing circuit to perform a negotiation service request in accordance with an embodiment of the present disclosure. This exemplary code 400 for a negotiation related processing between two parties when executed gives two parties various options to choose from. They dictate their terms individually and we remain mediator or facilitator. Retrieving their new numbers in case of negotiation.

```
    public function
updateActiveNegotiationPage($activeNegotiationId,$serviceRequestId,
$option,$key){
    $data=ActiveNegotiation::find($activeNegotiationId);
    $serviceRequest=ServiceRequest::find($serviceRequestId);
    if($data==null){
      return view(‘templates.negotiation.update_failed’);
      return json_encode(array([‘success’ => false, ‘error’ => true,
‘message’ => ‘Invalid Request.’]));
    }
    if($data->primary_request_id==$serviceRequestId){
      if($data->primary_key!=$key){
        return view(‘templates.negotiation.update_failed’);
        return json_encode(array([‘success’ => false, ‘error’ => true,
‘message’ => ‘Invalid Request.’]));
      }
      $data->my_offer=$data->primary_negotiation_value;
      $data->other_offer=$data->secondary_negotiation_value;
      $data->request_id=$serviceRequestId;
      $data->option=$option;//1 for update,2 for meetin middle ,
//3 for stay at current
      $data->email=$serviceRequest->notification_email_id;
      $data->min;
      $data->max;
      $data->key=$data->primary_key;
      $data->term=$data->primary_negotiation_term;
      if($option==1){
        $data->my_value=$data->my_offer;
      }else if($option==2){
        $data->my_value=($data->primary_negotiation_value+$data-
>secondary_negotiation_value)/2;
      }else{
        $data->my_value=data->my_offer;
      }
      $isSatisfied=$this->doOperatorCalculation($data->index,$data-
>primary_negotiation_value,$data->secondary_negotiation_value,$data-
>operator);
      if($isSatisfied==0){
        if($data->primary_negotiation_value>=$data-
>secondary_negotiation_value){
            $data->max=true;
        }else{
            $data->min=true;
        }
      }else{
        if($data->primary_negotiation_value>=$data-
>secondary_negotiation_value){
          $data->min=true;
        }else{
          $data->max=true;
        }
      }
```

### Trimodal Negotiation

An expedited machine and system negotiation feature of the present disclosure occurs between two parties when their interests are closely matched but not completely matched. Coded non-transitory processor-readable storage media instructions executed by at least one processing circuit to perform a service request for automated negotiations, also known as the RoboNegotiator™ system, are disclosed herein.

The RoboNegotiator™ solution is intended to act as a mediator, a negotiator and also as a facilitator to explore an individual's wishes which they may not explore with their real-world identity. A user will never be sure that there is another matching User for his/her request. Similarly, another User, even if he exists, will not know about the message User1 has posted for User2 unless both have matching terms for each other.

RoboNegotiator™ provides neutral and anonymous matching to businesses and consumers through three unique services, 1) Introduction of compatible parties, 2) automatic and guided negotiation with unknown or known parties and 3) verification of mutual interests. RoboNegotiator™ provides all these services securely while exposing deal terms and identities to only matched parties.

RoboNegotiator™ is initiating change in the market place. Now high cost deals including Real Estate and Automobiles, Time bound inventory including empty flights and even E*Commerce averse businesses including luxury brands can go out and touch formally unknown customers through RoboNegotiator's secret but independent “Matching As A Service” capabilities.

In a disclosed embodiment, matches occur on a first come first serve basis or first in first out basis but a negotiation is open to a better offer in the middle of a negotiation in the interest of at least one of the parties. An option is also included which locks the parties in negotiation after a match on anonymity is found unless both parties consent to an open negotiation in a third party's interest.

There are at least three operating modes for the disclosed system. The modes are known as classic, automatic and guided. The Classic mode handles deals the way deals are handled in the ‘real world’ between two or more parties without digital automation or digital circuits. Buyer and Seller offers are relayed to each other openly with the blackbox or RoboNegotiator™ as the communicator via email or text and other media. The process happens without the need for face-to-face communication.

An embodiment includes a tri-operating mode module for the disclosed system including classic, automatic and guided modes where the automatic mode uses the match database, match engine and match engine logic. The guided mode is a hybrid of the automatic mode and the classic mode which simply introduces matching clients.

The Automatic mode gets the lowest price the seller is willing to sell at the highest price the buyer is willing to go with. The blackbox and RoboNegotiator™ match the best possible parties with one another with a focus on making sure they both save some money and more importantly time via the disclosed match engine components, circuits, modules and non-transitory computer readable instructions.

The Guided mode gets preferences from both sides to engage them in negotiations according to their preferences. One side can choose the disclosed system to manage negotiation and the other side may prefer to negotiate on his or her own. All communication is done in a neutral, unbiased manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention.

Accordingly, it is not intended that the disclosure be limited, except as by the specification and claims set forth herein. While the foregoing is directed to embodiments of the present invention, other and further embodiments of the invention may be devised without departing from the basic scope of the disclosure.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A match engine, comprising:
a fully associative relational database for saving an anonymity preference order for a plurality of existing user's with an associated relational data including like and similar items or services advertised and traded in commerce for consideration;
a matching engine configured to compare a new user's anonymity preference order for an anonymity match in the fully relational database against an anonymity preference order for all existing users;
a matching engine logic configured to compare the new user's relational data for an associative relational match in the fully associative relational database against a respective relational data for all existing users based on the anonymity match occurring; and
a matching rules module configured to define a plurality of transaction types to determine a successful match and to define a plurality of resulting actions absent a match to enable an automatic and expedited trimodal negotiation system.

2. The match engine of claim 1, wherein the anonymity match and the relational match occur simultaneously.

3. The match engine of claim 1, wherein the fully associative relational database includes multiports for simultaneous comparison threads and instantiated circuits and hardware on all relational types in the database for any number of users.

4. The match engine of claim 1, wherein the trimodal negotiation system comprises a partial compare module configured to match on a partial relational data and enable a negotiation for a remaining unmatched data concurrently, in one of an unbiased automated, semi-automated and non-automated mode.

5. The match engine of claim 1, wherein a relational data type comprises a set of business rules for each user.

6. The match engine of claim 1, wherein the relational match is based on opposite types of relational data.

7. The match engine of claim 1, wherein a relational match occurs across associative types of relational data including an exemplary user's product need matched to a romantic status for the user.

8. The match engine of claim 1, wherein a user's anonymity match and relational match occurs in a one to one ratio and a one to a plurality ratio and a plurality to a plurality.

9. The match engine of claim 1, wherein all matches occur asynchronously with respect to an internal clock of the relational database and an arrival of a new user.

10. The match engine of claim 1, wherein a relational data is matched across semi associative relational data for one price to a user and a relational data is matched across all fully associative relational data for a higher price to a user.

11. The match engine of claim 1, wherein the anonymity preference order includes a geographical proximity data type for the new user in relation to a geographical proximity data type for all existing users.

12. The match engine of claim 1, wherein an anonymity data and a relational data for each user comprises an expiry and an expiration thereof makes the respective data ineligible for any match.

13. The match engine of claim 1, further comprising a negotiation module configured to handle requests on a first come first serve basis also known as a first in first out basis where a negotiation is open to a better offer in the middle of a negotiation in the interest of at least one of the parties.

14. A match engine system, comprising:
a fully associative relational database for saving an anonymity preference order for a plurality of existing user's with an associative relational data including like and similar items or services advertised and traded in commerce for consideration;
a matching engine configured to check a new user's anonymity preference order for an anonymity match in the fully relational database against an anonymity preference order for all existing users;
a matching engine logic configured to check the new user's relational data for an associative relational match in the fully associative relational database against a respective relational data for all existing users;
a matching rules module configured to define a plurality of transaction types to determine a successful match and to define a plurality of resulting actions absent a match to enable an automatic and expedited trimodal negotiation system; and
a request watcher module configured to continuously watch for any new match requests at a request dump folder and notify the matching engine thereof for processing.

15. The match engine system of claim 14, further comprising a partial compare module configured to match on a partial relational data and enable a negotiation for a remaining unmatched data concurrently, in one of an unbiased automated, semi-automated and non-automated mode.

16. The match engine of claim 14, further comprising a request receiver configured to receive match requests from a web service application programming interface and pass them to a request dump folder.

17. The match engine of claim 14, wherein the request dump folder is configured to store a plurality of match requests and pass respective data associated with the match requests to the match engine for comparing and processing.

18. A match engine and system, comprising:
a fully associative relational database for saving an anonymity preference order for a plurality of existing client's with an associative relational match and for saving matched and unmatched requests;
a matching engine configured to compare a new client's anonymity preference order for an anonymity match in the fully relational database against an anonymity preference order for all existing clients;
a matching engine logic configured to compare the new client's relational data for an associative relational match in the fully associative relational database against a respective relational data for all existing clients;
a matching rules module configured to define a plurality of transaction types to determine a successful match and to define a plurality of resulting actions absent a match to enable an automatic and expedited trimodal negotiation system;
a partial compare module configured to match on a partial relational data and enable a negotiation for a remaining unmatched data concurrently, in one of an unbiased automated, semi-automated and non-automated mode; and
a responder module configured to pass anonymity and relational information regarding clients of a match event from the match database to a notification module.

19. The match engine of claim 18, further comprising a tri-operating mode module for the disclosed system including classic, automatic and guided modes where the automatic mode uses the match database, match engine and logic and the guided mode is a hybrid of the automatic mode and the classic mode which simply introduces matching clients.

20. The match engine of claim 18, wherein multiple match requests are processed simultaneously in different threads on instantiated circuits and logic starting at a request dump and continuing through a request watcher, the match engine and logic to a responder module.
